(19) United States
(12) Patent Application Publication
(10) Pub. No.: US 2007/0060196 A1
(43) Pub. Date: Mar. 15, 2007

(54) Call delivery between networks serving a dual mode wireless communication device

(75) Inventor: Alok Sharma, Lisle, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/226,173

(22) Filed: Sep. 14, 2005

(51) Int. Cl. H04M 1/00

(52) U.S. Cl. 455/552.1

(57) ABSTRACT

Communication networks and methods are disclosed that provide call delivery to a dual mode wireless communication device served by a wireless data network (e.g., an IMS/WiFi network) and a wireless voice network (e.g., cellular network). A common subscriber database includes subscriber data for the dual mode device. A call received to the dual mode device is routed to a call control function in one of the wireless networks. The call control function then queries the common subscriber database to determine in which network the dual mode device is currently registered. The call control function then routes the call to the dual mode device through the proper network.

### BACKGROUND OF THE INVENTION

1. Field of the Invention

The invention is related to the field of communication networks and, in particular, to call delivery between two or more networks serving a dual mode wireless communication device.

2. Statement of the Problem

Wireless phone providers are developing dual mode phones that have the functionality for cellular wireless networking (e.g., CDMA or GSM) and WiFi wireless networking (e.g., 802.11b, 802.11g, etc). The concept of the dual mode phone is to allow a user flexibility to communicate with either the cellular network or a WiFi network. WiFi networks are typically used for data communications such as Internet browsing, email, etc. WiFi networks may also be used for voice communications in the form of VoIP calls. Cellular networks are typically used for voice communications, but have also been adapted for data communications.

The dual mode phones take advantage of the WiFi “hot spots” in a corporation or enterprise, airports, book stores, coffee shops, etc, that are becoming more common. When a dual mode phone is in range of a WiFi hot spot, the phone may access the Wireless LAN (WLAN) for data communications, VoIP calls, etc. The WLAN generally provides a higher bandwidth than cellular networks for more efficient data transfer. If the dual mode phone roams out of a WLAN, then the phone can switch over to the cellular network for voice or data communication.

A WiFi network may be integrated with an IP Multimedia Subsystem (IMS). The 3^{rd} Generation Partnership Project (3GPP) has set forth specifications describing the architecture of IMS networks and networking. Service providers are accepting this architecture in next generation network evolution. The IMS architecture is initially defined by the 3GPP to provide multimedia services to mobile subscribers over an IP network. IP networks have become the most cost savings bearer network to transmit video, voice, and data. IMS uses the advantage of IP networks to provide multimedia services for IMS subscribers on an IMS platform. The signaling used within IMS networks is generally Session Initiation Protocol (SIP). IMS defines the standard SIP interface between application servers (AS), the IMS core network (CSCF), the IMS subscriber (user), the IMS database (HSS), and IMS billing elements. On the IMS platform, the traditional supplementary services, such as call forwarding, conferencing, and call waiting could be available for IMS subscribers. Also, many new data services, such as instant messaging, video calls, video on wait, and web-based services, will also be available for the IMS subscribers.

The capability of a phone communicating with two different networks creates networking issues. For instance, if a caller dials a number for a user having a dual mode phone, that call may be routed to the phone over either the cellular network or the IMS/WiFi network. One problem facing network managers is call delivery when there are two networks available to the dual mode phone. More particularly, network managers need to determine which network to route the call over so that it may be received by the dual mode phone. There are currently no standards available to address the call delivery issues for dual mode subscribers.

### SUMMARY OF THE SOLUTION

The invention solves the above and other related problems by using a common subscriber database for the two networks serving a dual mode subscriber. The common subscriber database maintains a subscriber record for the dual mode subscriber indicating in which network the subscriber's dual mode phone is currently registered. When a call to the dual mode phone is received, the common subscriber database indicates in which network the subscriber's dual mode phone is currently registered. The call is then delivered or routed to that network for subsequent transfer to the dual mode phone.

By using the common subscriber database, call delivery can be managed more effectively between the two networks. Also, subscriber data may be stored in a single location for call delivery purposes. By solving call delivery problems, service providers can more effectively provide dual mode communications to their subscribers.

In one embodiment of the invention, a communication network includes a transport network, a wireless data network, a wireless voice network, and a common subscriber database. An example of the wireless data network includes an IMS network and a Wireless Local Area Network (WLAN) using WiFi/WiMax communications. An example of the wireless voice network includes a cellular network, such as a CDMA network or a GSM network. The wireless data network and the wireless voice network are both adapted to communicate with a dual mode wireless communication device.

If the transport network receives a call to the communication device, then the transport network routes the call to either the wireless data network or the wireless voice network depending on desired implementations. A call control function in one of the networks receives the call to the communication device. The call control function transmits a query to the subscriber database to determine in which network the communication device is currently registered. The subscriber database stores and maintains subscriber data for one or more subscribers. The subscriber database transmits a response to the call control function indicating the network in which the communication device is registered.

If the communication device is registered in the wireless data network, then the call control function routes the call to the communication device through the wireless data network. If the communication device is registered in the wireless voice network, then the call control function routes the call to the communication device through the wireless voice network.

There may be instances where the subscriber database does not respond to the query from the call control function. To avoid having call delivery delayed in the network beyond a desired time, the call control function sets a timer when transmitting the query to the subscriber database. The call control function then monitors the timer. If the timer expires, then the call control function provides secondary call treatments for the call.

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of operating a communication network to provide call delivery to a dual mode wireless communication device in an exemplary embodiment of the invention.

FIG. 3 is a flow chart illustrating a method of initiating secondary call treatments in an exemplary embodiment of the invention.

FIG. 4 illustrates another embodiment of a communication network.

FIGS. 5-8 are message diagrams illustrating examples of call delivery and secondary call treatment in the communication network of FIG. 4.

### DETAILED DESCRIPTION OF THE INVENTION

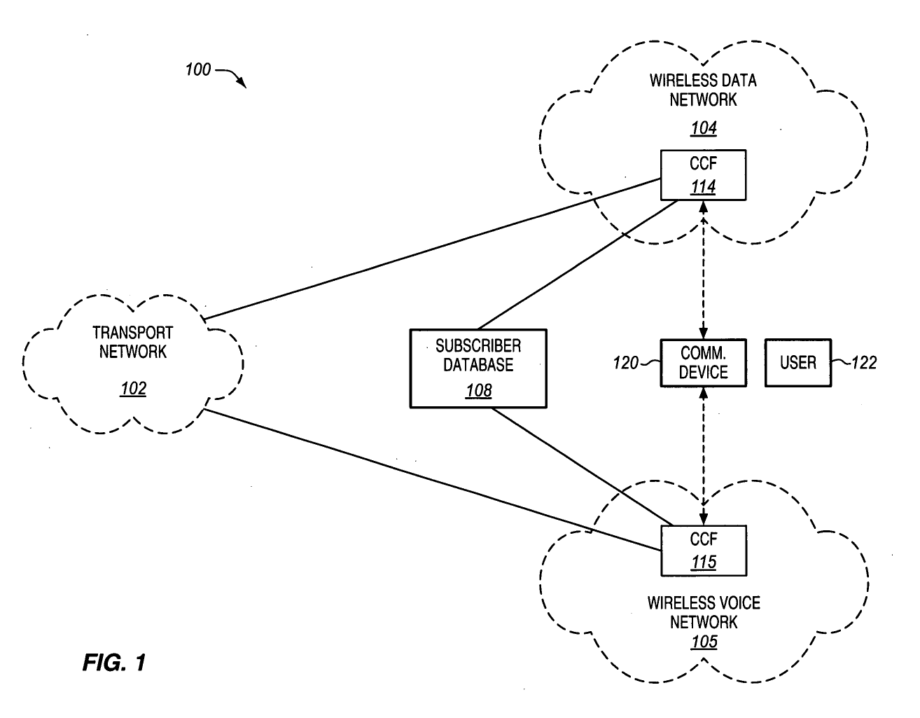

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes a transport network 102, a wireless data network 104, a wireless voice network 105, and a common subscriber database 108. The network clouds illustrating the networks are not being used to show the actual service areas of the networks, as the service areas may be separate or overlap. Wireless data network 104 and wireless voice network 105 are separate networks generally used for different purposes (one for data, one for voice). However, both networks 104-105 may be managed or owned by a common service provider. Common subscriber database 108 is shown as being outside of networks 104-105, but common subscriber database 108 may be implemented inside either or both of networks 104-105 or may be implemented in a remote system. Communication network 100 may include other networks, systems, or devices not shown in FIG. 1.

Transport network 102 comprises any network adapted to transport a call to one or both of wireless data network 104 and wireless voice network 105. Examples of transport network 102 include a circuit-based network (e.g., a Public Switched Telephone Network (PSTN)) or a packet-based network (e.g., an internet).

Wireless data network 104 comprises any network that typically provides data communications via wireless signals. An example of wireless data network 104 includes a Wireless Local Area Network (WLAN) using WiFi/WiMax communications. The internal networking of wireless data network 104 may use technologies such as the IMS architecture described by the 3GPP. An example implementation of wireless data network 104 may be as an enterprise network in a corporation or campus, or as a “hot spot” in popular public places, such as an airport, coffee shop, etc. Although wireless data network 104 is typically used for data communication, those skilled in the art understand that data networks may transport voice communications, such as VoIP calls.

Wireless data network 104 includes a call control function (CCF) 114 adapted to serve a dual mode wireless communication device 120 (referred to herein as “communication device”). An example of CCF 114 in an IMS network may be a Call Service Control Function (CSCF) and/or an Application Server (AS). Communication device 120 is being operated by a user 122 that subscribes to a dual mode service offered by a service provider.

Wireless voice network 105 comprises any network that typically provides voice communications via wireless signals. An example of wireless voice network 105 includes a cellular network, such as a CDMA network or a GSM network. Although wireless voice network 105 is typically used for voice communication, those skilled in the art understand that voice networks may also transport data communications. Wireless voice network 105 includes a call control function (CCF) 115 adapted to serve communication device 120. An example of CCF 115 in a cellular network may be a Mobile Switching Center (MSC).

Common subscriber database 108 comprises any database or similar system that stores and maintains subscriber data for one or more subscribers. For instance, subscriber database 108 may maintain subscriber data in the form of a subscriber record for user 122. Subscriber database 108 is accessible by either wireless data network 104 or wireless voice network 105 so that either network 104 or 105 may retrieve subscriber data. Subscriber database 108 may comprise a single centralized system or may be distributed among multiple systems. If implemented in multiple systems, the systems communicate to maintain common subscriber records. If wireless data network 104 comprises an IMS network and wireless voice network 105 comprises a cellular network, then one example of subscriber database 108 may be a combined Home Location Register (HLR)/Home Subscriber Server (HSS).

User 122 may be in range of one or both of wireless data network 104 and wireless voice network 105. If user 122 is in range of wireless data network 104, then communication device 120 registers with wireless data network 104 and call control function 114 serves communication device 120. If user 122 is in range of wireless voice network 105, then communication device 120 registers with wireless voice network 105 and call control function 115 serves communication device 120. If user 122 is in range of both networks 104-105, then communication device 120 registers with one of the networks 104-105 either by selection of user 122 or by an automatic default parameter. When communication device 120 registers with one of the networks 104-105, the associated call control function 114-115 updates subscriber database 108 with the proper subscriber data.

Assume that transport network 102 receives a call to communication device 120. The call may comprise a traditional circuit-based call or a VoIP call. Transport network 102 routes the call to either wireless data network 104 or wireless voice network 105 depending on desired implementations.

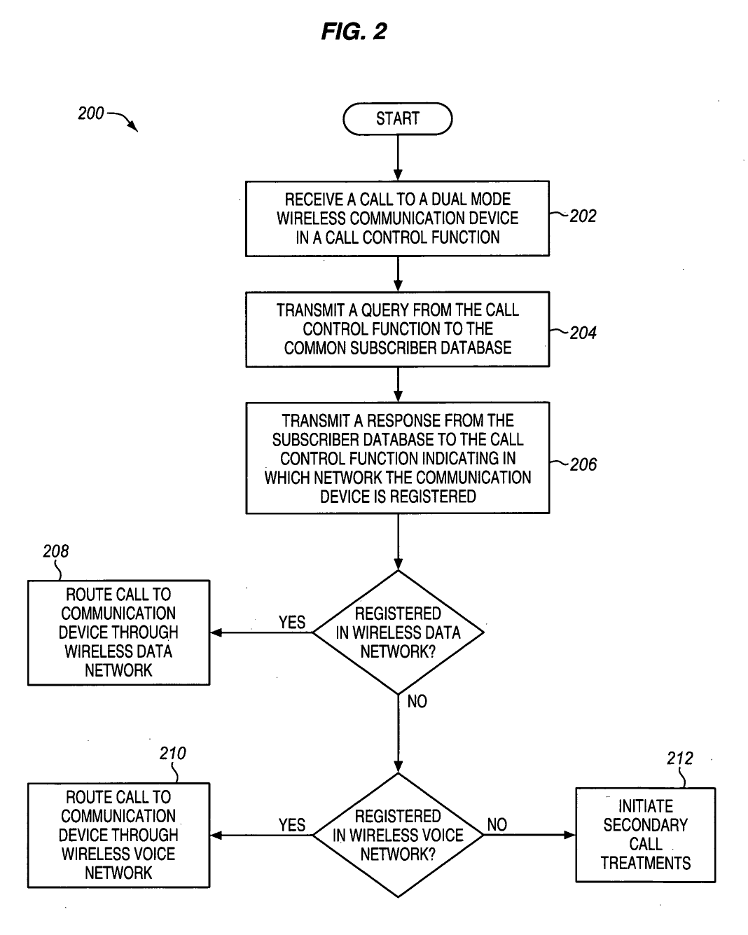

FIG. 2 is a flow chart illustrating a method 200 of operating a communication network to provide call delivery to a dual mode wireless communication device in an exemplary embodiment of the invention. The steps of method 200 will be described with reference to communication network 100 in FIG. 1. The steps of the flow chart in FIG. 2 are not all inclusive and may include other steps not shown.

In step 202 of method 200, either CCF 114 or CCF 115 receives the call routed by transport network 102. The CCF 114 or 115 receiving the call is left up to desired implementations. Responsive to receiving the call, the receiving CCF 114 or 115 transmits a query to subscriber database 108 to determine in which network 104 or 105 communication device 120 is currently registered in step 204. Subscriber database 108 processes the query to identify a subscriber record for user 122 and/or communication device 120. The query may include a dialed number for the call that subscriber database 108 uses to identify the subscriber record for user 122. The subscriber record indicates in which network 104 or 105 communication device 120 is registered. Subscriber database 108 transmits a response to CCF 114 or 115 indicating the network 104 or 105 of registration in step 206.

If communication device 120 is registered in wireless data network 104, then CCF 114 or 115 routes the call to communication device 120 through wireless data network 104 in step 208. For instance, if CCF 114 in wireless data network 104 is the CCF receiving the call, then CCF 114 can merely route the call to communication device 120 through wireless data network 104 in a conventional manner. If CCF 115 in wireless voice network 105 is the CCF receiving the call, then CCF 115 needs to route the call to CCF 114 in wireless data network 104. CCF 115 may route the call to CCF 114 over transport network 102 or over another intervening connection not shown in FIG. 1. CCF 114 may then route the call to communication device 120 through wireless data network 104 in a conventional manner.

If communication device 120 is registered in wireless voice network 105, then CCF 114 or 115 routes the call to communication device 120 through wireless voice network 105 in step 210. For instance, if CCF 114 in wireless data network 104 is the CCF receiving the call, then CCF 114 needs to route the call to CCF 115 in wireless voice network 105. CCF 114 may route the call to CCF 115 over transport network 102 or over another intervening connection not shown in FIG. 1. CCF 115 may then route the call to communication device 120 through wireless voice network 105 in a conventional manner. If CCF 115 in wireless voice network 105 is the CCF receiving the call, then CCF 115 can merely route the call to communication device 120 through wireless voice network 105 in a conventional manner.

If communication device 120 is not registered in either network 104 or 105, then CCF 114 or 115 may initiate secondary call treatments in step 212 as is further described below.

The above method 200 advantageously provides an effective method of call delivery between networks 104-105. Because there has not been prior convergence between networks as described above, calls would likely go unanswered due to being routed to the wrong network. For instance, if a cellular network received a call to a user but the user was currently registered with an enterprise WiFi network, then the call may be sent to voice mail even though the user was available over the enterprise WiFi network. The convergence of the networks, such as through the common subscriber database, allows for more effective call delivery between the multiple networks.

There may be instances where subscriber database 108 does not respond to the query in step 206 so that CCF 114 or 115 cannot route the call to communication device 120. For instance, user 122 may have roamed out of the service area for one or both of networks 104-105, and subscriber database 108 responds with an error message. In another instance, subscriber database 108 may be experiencing congestion or problems such that it cannot respond to CCF 114 or 115 in a desired time frame. If the serving CCF 114 or 115 cannot route the call to communication device 120, then CCF 114 or 115 provides secondary call treatments for the call. Examples of secondary call treatments are voice mail, call forwarding, etc.

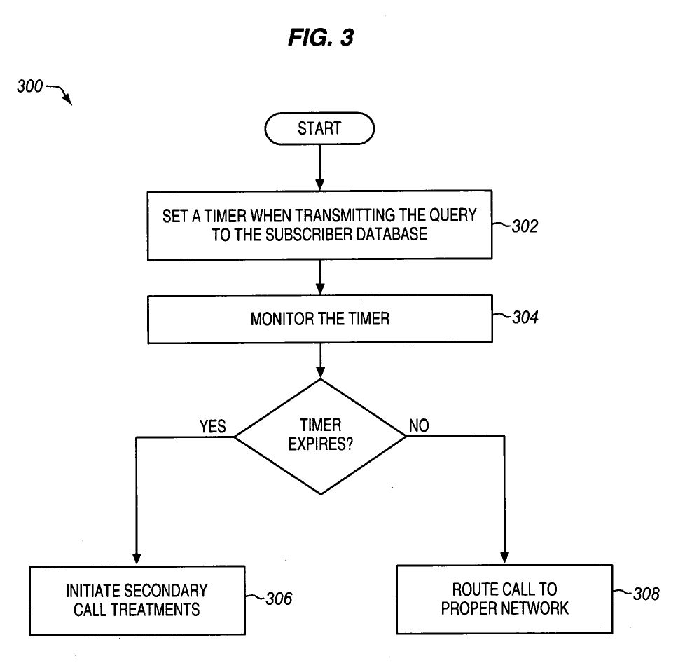

FIG. 3 is a flow chart illustrating a method 300 of initiating secondary call treatments in an exemplary embodiment of the invention. The steps of method 300 will be described with reference to communication network 100 in FIG. 1. The steps of the flow chart in FIG. 3 are not all inclusive and may include other steps not shown.

In step 302, CCF 114 or 115 sets a timer (T1) when transmitting the query to subscriber database 108 (see step 204 of FIG. 2). CCF 114 or 115 then monitors the timer in step 304. If the timer expires, then CCF 114 or 115 initiates secondary call treatments in step 306. If CCF 114 or 115 receives a response from subscriber database 108 before the timer expires, then CCF 114 or 115 routes the call as described in steps 206-210 of FIG. 2 (step 308). If CCF 114 or 115 receives an error message from subscriber database 108 before the timer expires, then CCF 114 or 115 provides secondary call treatments (step 306).

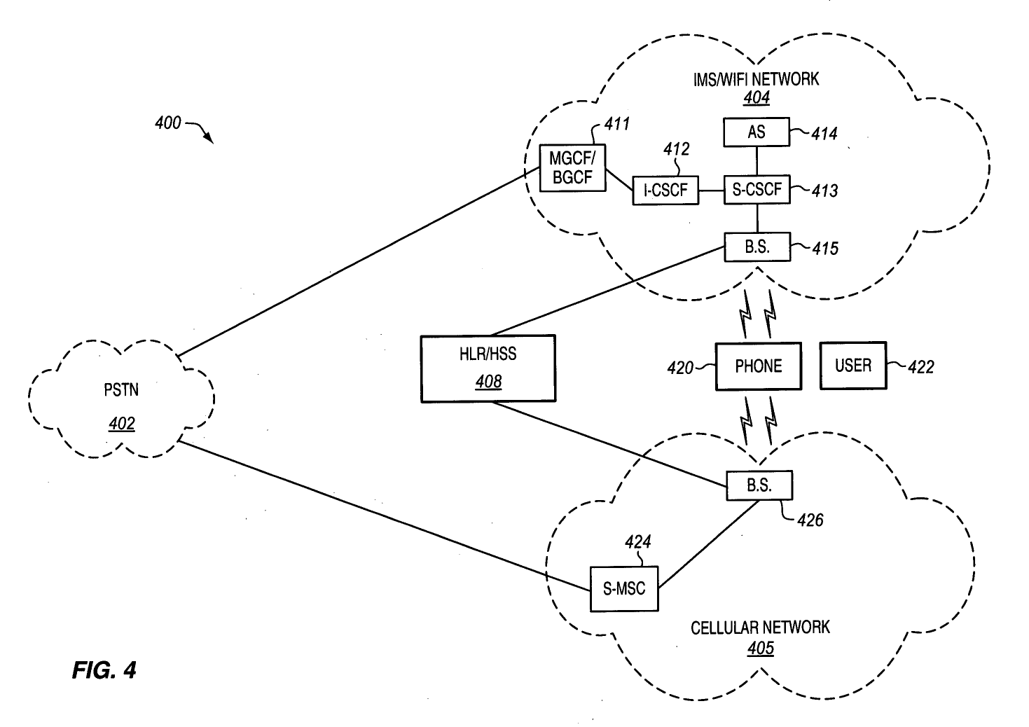

FIG. 4 illustrates another embodiment of a communication network 400 in an exemplary embodiment of the invention. Communication network 400 includes a PSTN 402, an IMS/WiFi network 404, a cellular network 405, and a combined HLR/HSS element 408. The network clouds illustrating the networks 404-405 are not being used to show the actual service areas of the networks, as the service areas may be separate or overlap. IMS/WiFi network 404 and cellular network 405 are separate networks generally used for distinct purposes. IMS/WiFi network 404 is generally used for data communications. Cellular network 405 is generally used for voice communications. However, networks 404-405 and HLR/HSS element 408 may be managed by the same service provider, such as Verizon, Sprint, Cingular, etc. HLR/HSS 408 is shown as being outside of networks 404-405, but HLR/HSS 408 may be implemented inside either or both of networks 404-405 or may be implemented in a remote system. Communication network 400 may include other networks, systems, or devices not shown in FIG. 4.

IMS/WiFi network 404 is a combined IMS network and WiFi/WiMax network using wireless technologies, such as 802.11b or 802.11g. IMS/WiFi network 404 may comprise an enterprise network in a large corporation, a large campus, etc. IMS/WiFi network 404 includes a Media Gateway Control Function (MGCF)/Breakout Gateway Control Function (BGCF) 411, a Interrogate Call Session Control Function (I-CSCF) 412, a Serving Call Session Control Function (S-CSCF) 413, an Application Server (AS) 414, and a base station (B.S.) 415. MGCF/BGCF 411, I-CSCF 412, S-CSCF 412, and AS 414 are known to those familiar with the 3GPP specifications on IMS networks. Base station 415 is a WiFi/WiMax transceiver used to communicate with WiFi devices, such as dual mode phone 420. IMS/WiFi network 404 may include many more base stations 415 that are not shown for the sake of brevity.

Cellular network 405 comprises any cellular network, such as a CDMA network or a GSM network. Cellular network 405 includes a Serving Mobile Switching Center (S-MSC) 424 and a base station (B.S.) 426. S-MSC 424 includes a Visitor Location Register (VLR) as is known in the art.

HLRs are known in cellular networks as databases used to store subscriber records. Similarly, HSSs are known in IMS networks as databases used to store subscriber records. HLR/HSS 408 is a combined HLR/HSS. HLR/HSS 408 may be a physically combined unit, or may comprise multiple units that synchronize their subscriber data such that they appear to be a single unit.

User 422 of phone 420 may be in range of one or both of IMS/WiFi network 404 and cellular network 405. If user 422 is in range of IMS/WiFi network 404, then phone 420 registers with IMS/WiFi network 404, and S-CSCF 413 serves phone 420. If user 422 is in range of cellular network 405, then phone 420 registers with cellular network 405, and MSC 424 serves phone 420. If user 422 is in range of both networks 404-405, then phone 420 registers with one of the networks 404-405 either by selection of user 422 or by an automatic default parameter. When phone 420 registers with one of the network 404-405, HLR/HSS 408 is updated with the proper subscriber data.

Assume that PSTN 402 receives a call to phone 420. PSTN 402 routes the call to either IMS/WiFi network 404 or cellular network 405 depending on desired implementations. For this embodiment, assume that calls are routed to IMS/WiFi network 404 as a default.

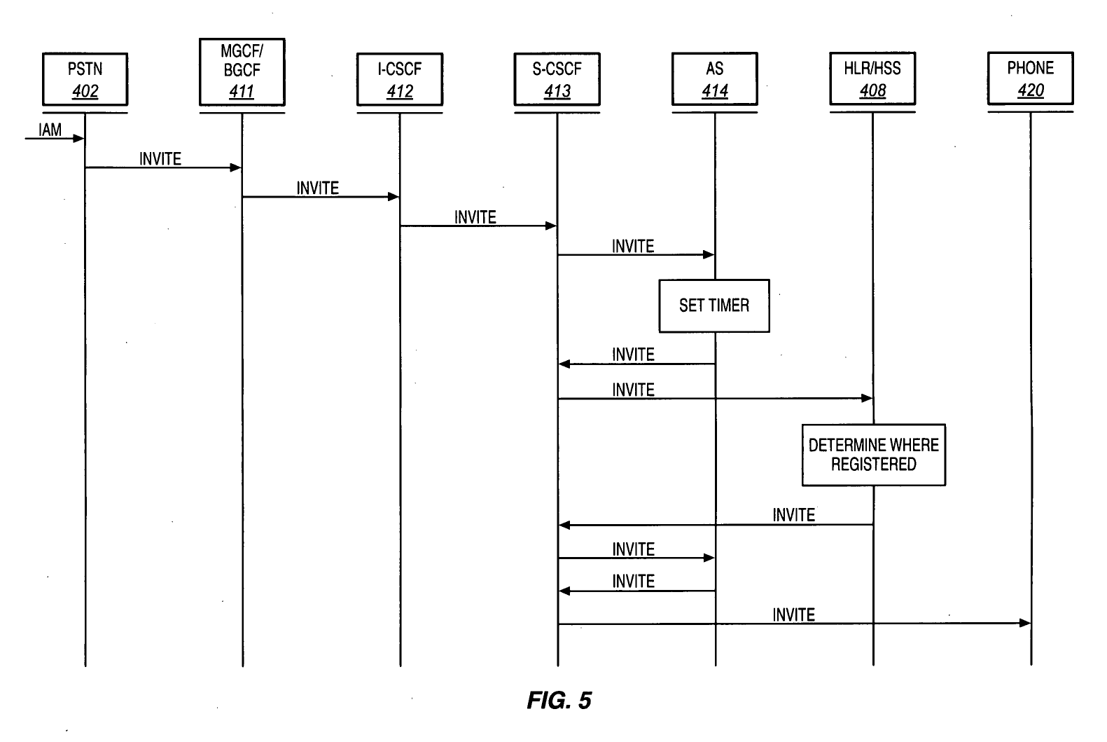

FIGS. 5-8 are message diagrams illustrating examples of call delivery and secondary call treatment in communication network 400.

FIG. 5 illustrates an example where phone 420 is registered in IMS/WiFi network 404. PSTN 402 receives the call to phone 420 in the form of a call setup message, such as an Initial Address Message (IAM) or some other ISDN User Part (ISUP) message. PSTN 402 transmits a Session Initiation Protocol (SIP) INVITE message to MGCF/BGCF 411. The INVITE message includes a subscriber ID for phone 420 or user 422. MGCF/BGCF 411 then transmits an INVITE message to S-CSCF 413 through I-CSCF 412. S-CSCF 413 transmits an INVITE message to AS 414. AS 414 determines that user 422 is a dual mode subscriber based on the subscriber ID. AS 414 then sets a timer (T1) and transmits an INVITE message to HLR/HSS 408 through S-CSCF 413. The INVITE message acts as a query to determine in which network 404 or 405 phone 420 is registered.

Responsive to the INVITE message, HLR/HSS 408 determines in which network 404 or 405 phone 420 is registered. In this example, phone 420 is registered in IMS/WiFi network 404. HLR/HSS 408 transmits an INVITE message to S-CSCF 413 indicating that phone 420 is registered in IMS/WiFi network 404. S-CSCF 413 transmits an INVITE message to AS 414 indicating that S-CSCF 413 received a valid response from HLR/HSS 408. S-CSCF 413 also transmits an INVITE message to phone 420 through base station 415 and possibly other systems to complete the call through IMS/WiFi network 404 to phone 420. Because AS 414 receives an indication that HLR/HSS 408 transmitted a valid response to S-CSCF 413 before the timer expires, AS 414 does not provide secondary call treatments and allows the call to complete as normal. Based on this implementation, communication network 400 effectively selects the appropriate network 404 or 405 to provide call delivery to phone 420.

If phone 420 was registered in another external HSS (not shown), then HLR/HSS 408 would use standards-based subscribe/notify functionality via the Diameter interface to get the subscriber-related data. S-CSCF 413 may then route the call based on the acquired subscriber-related data.

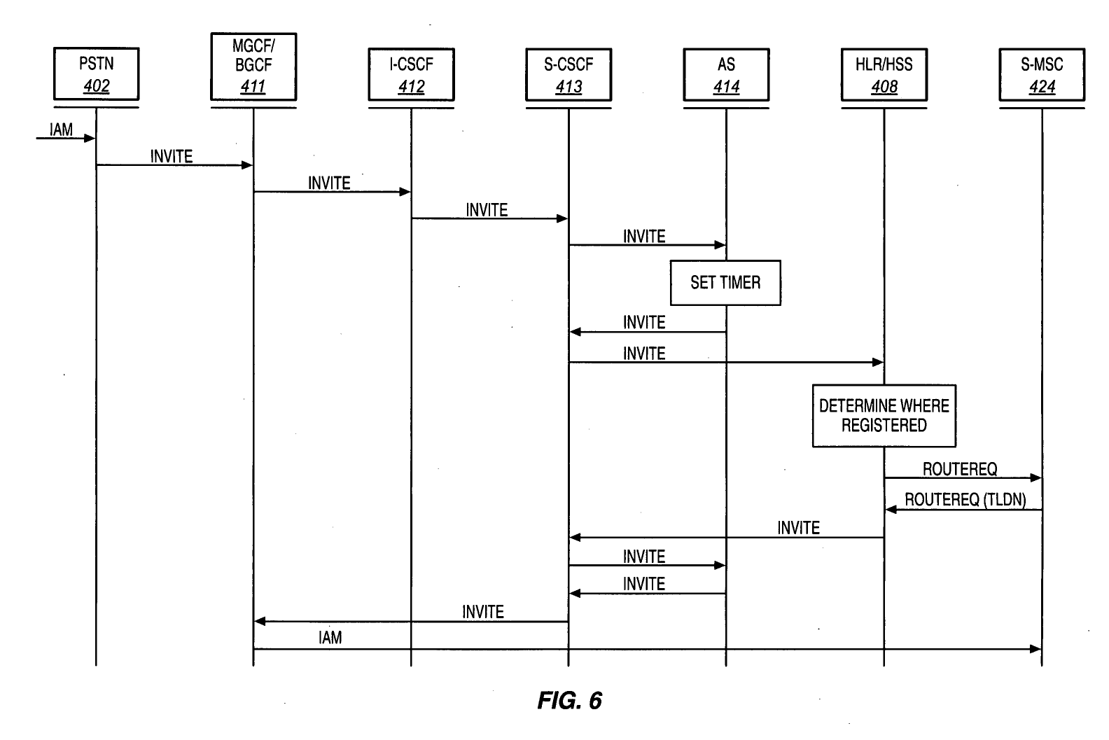

FIG. 6 illustrates an example where phone 420 is registered in cellular network 405. The messaging in FIG. 6 flows as in FIG. 5 so that HLR/HSS 408 receives an INVITE message from S-CSCF 413. Responsive to the INVITE message, HLR/HSS 408 determines in which network 404 or 405 phone 420 is registered. In this example, phone 420 is registered in cellular network 405. HLR/HSS 408 transmits a route request message (ROUTREQ) message to S-MSC 424 to determine routing information for the call. S-MSC 424 responds with a route request message indicating a temporary local directory number (TLDN) for the call. Responsive to the route request message, HLR/HSS 408 transmits an INVITE message to S-CSCF 413 indicating the TLDN. S-CSCF 413 transmits an INVITE message to AS 414 indicating that S-CSCF 413 received a valid response from HLR/HSS 408. Because AS 414 receives an indication that HLR/HSS 408 transmitted a valid response to S-CSCF 413 before the timer expires, AS 414 does not provide secondary call treatments and allows the call to complete as normal.

Based on the response from HLR/HSS 408, S-CSCF 413 is able to determine that the call needs to be routed to cellular network 405. Thus, S-CSCF 413 transmits an INVITE message to MGCF/BGCF 411 indicating the TLDN for the call. Based on the TLDN, MGCF/BGCF 411 transmits an IAM to S-MSC 424 to complete the call to phone 420 through cellular network 405. For instance, S-MSC 424 receives the IAM, and transmits the appropriate call setup signaling to phone 420 through base station 426.

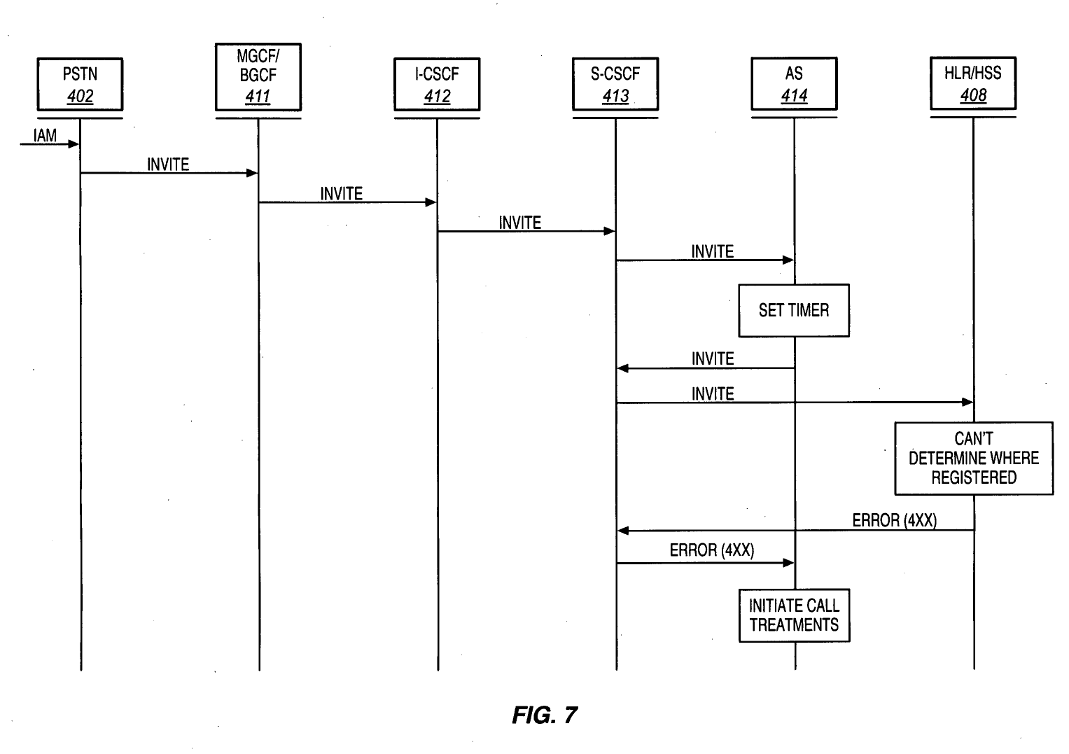

FIG. 7 illustrates an example where phone 420 is not registered in either network 404-405 or is not responding. The messaging in FIG. 7 flows as in FIG. 5 so that HLR/HSS 408 receives an INVITE message from S-CSCF 413. Responsive to the INVITE message, HLR/HSS 408 determines in which network 404 or 405 phone 420 is registered. In this example, phone 420 is not registered in either network 404-405 or is not responding. HLR/HSS 408 transmits an error message (4XX) to S-CSCF 413. S-CSCF 413 transmits the error message to AS 414. Responsive to the error message, AS 414 initiates secondary call treatments for the call. Secondary call treatments may include routing the call to a voice mail server, determining call forwarding information, etc.

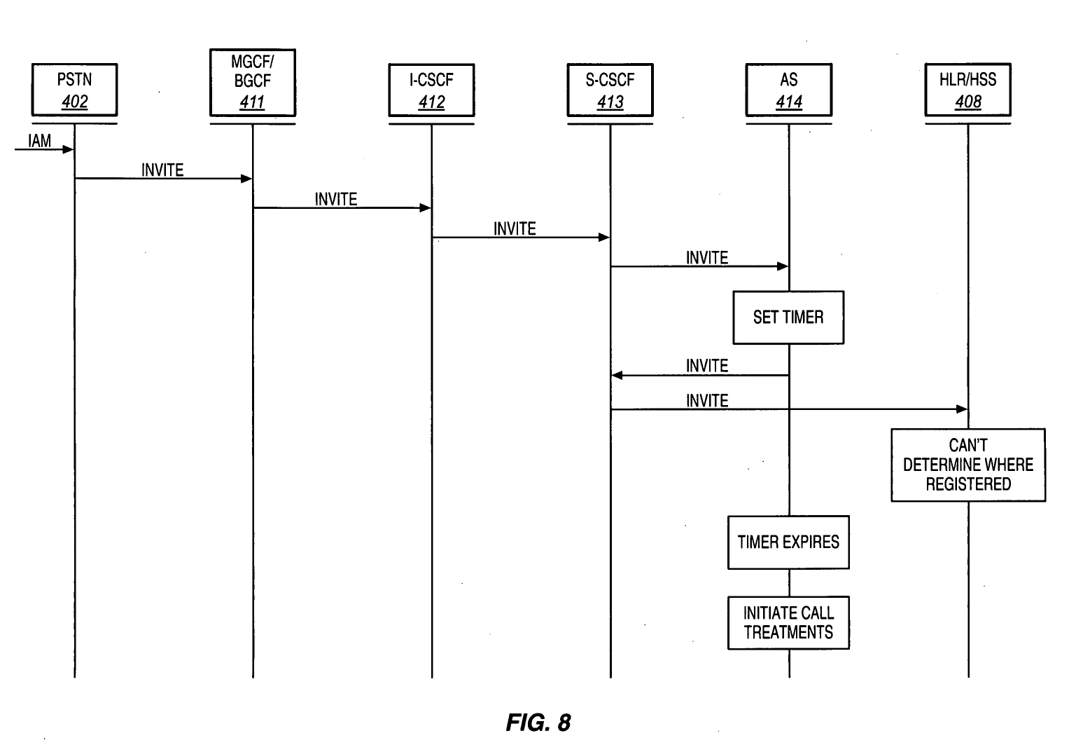

FIG. 8 illustrates an example where HLR/HSS 408 does not respond to S-CSCF 413 before the timer expires. The messaging in FIG. 8 flows as in FIG. 5 so that HLR/HSS 408 receives an INVITE message from S-CSCF 413. Responsive to the INVITE message, HLR/HSS 408 attempts to determine in which network 404 or 405 phone 420 is registered. HLR/HSS 408 may have problems in this determination. For instance, phone 420 may have previously registered in IMS/WiFi network 404 or cellular network 405, but is not responding to either of the networks 404-405. In another instance, the duration specified by the timer may be too short. In another instance, HLR/HSS 408 may encounter network delays when trying to get responses from other network elements, such as switches.

Before HLR/HSS 408 responds to the INVITE message from S-CSCF 413, AS 414 determines that the timer has expired. Responsive to the timer expiring, AS 414 initiates secondary call treatments for the call.

Although specific embodiments were described herein, the scope of the invention is not limited to those specific embodiments. The scope of the invention is defined by the following claims and any equivalents thereof.

I claim:

1. A communication network for providing call delivery to a dual mode wireless communication device, the communication network comprising:
a wireless data network having a call control function adapted to serve the dual mode wireless communication device;
a wireless voice network having a call control function adapted to serve the dual mode wireless communication device; and
a common subscriber database for the wireless data network and the wireless voice network having a subscriber record for a user of the dual mode wireless communication device;
wherein one of the call control functions receives a call to the dual mode wireless communication device;
wherein responsive to receiving the call, the receiving call control function and the common subscriber database are effective to route the call to the dual mode wireless communication device through the wireless data network if the dual mode wireless communication device is registered in the wireless data network, and to route the call to the dual mode wireless communication device through the wireless voice network if the dual mode wireless communication device is registered in the wireless voice network.

2. The communication network of claim 1 wherein the receiving call control function transmits a query to the common subscriber database to determine in which network the dual mode wireless communication device is registered, and receives a response to the query indicating in which network the dual mode wireless communication device is registered.

3. The communication network of claim 2 wherein the receiving call control function sets a timer when transmitting the query to the common subscriber database.

4. The communication network of claim 3 wherein:
if the timer expires before receiving a response from the common subscriber database, then the receiving call control function initiates secondary call treatments for the call.

5. The communication network of claim 1 wherein the wireless data network comprises an IMS/WiFi network.

6. The communication network of claim 1 wherein the wireless voice network comprises a cellular network.

7. The communication network of claim 1 wherein the call comprises a VoIP call.

8. The communication network of claim 1 wherein the common subscriber database comprises a Home Location Register (HLR)/Home Subscriber Server (HSS).

9. A method for operating a communication network to provide call delivery to a dual mode wireless communication device, wherein the communication network comprises a wireless data network, a wireless voice network, and a common subscriber database having a subscriber record for a user of the dual mode wireless communication device, the method comprising:
receiving a call to the dual mode wireless communication device in a call control function of one of the networks;
determining in which network the dual mode wireless communication device is registered based on the subscriber record in the common subscriber database;
routing the call to the dual mode wireless communication device through the wireless data network if the dual mode wireless communication device is registered in the wireless data network; and
routing the call to the dual mode wireless communication device through the wireless voice network if the dual mode wireless communication device is registered in the wireless voice network.

10. The method of claim 9 wherein determining in which network the dual mode wireless communication device is registered comprises:
transmitting a query from the receiving call control function to the common subscriber database to determine in which network the dual mode wireless communication device is registered; and
receiving a response to the query in the receiving call control function from the common subscriber database indicating in which network the dual mode wireless communication device is registered.

11. The method of claim 10 further comprising:
setting a timer in the receiving call control function when transmitting the query to the common subscriber database.

12. The method of claim 11 further comprising:
initiating secondary call treatments for the call if the timer expires before receiving a response from the common subscriber database.

13. The method of claim 9 wherein the wireless data network comprises an IMS/WiFi network.

14. The method of claim 9 wherein the wireless voice network comprises a cellular network.

15. The method of claim 9 wherein the call comprises a VoIP call.

16. The method of claim 9 wherein the common subscriber database comprises a Home Location Register (HLR)/Home Subscriber Server (HSS).

17. A communication network for providing call delivery to a dual mode wireless communication device adapted to communicate with a wireless data network and a wireless voice network, the communication network comprising:
a call control function in one of the wireless data network or the wireless voice network that is adapted to serve the dual mode wireless communication device; and
a subscriber database having a subscriber record for a user of the dual mode wireless communication device;
wherein the call control function receives a call to the dual mode wireless communication device, transmits a query to the subscriber database to determine if the dual mode wireless communication device is registered in the wireless data network or the wireless voice network, receives a response to the query indicating in which network the dual mode wireless communication device is registered, routes the call to the dual mode wireless communication device through the wireless data network if the dual mode wireless communication device is registered in the wireless data network, and routes the call to the dual mode wireless communication device through the wireless voice network if the dual mode wireless communication device is registered in the wireless voice network.

18. The communication network of claim 17 wherein the call control function sets a timer when transmitting the query to the subscriber database.

19. The communication network of claim 18 wherein:
if the timer expires before receiving a response from the subscriber database, then the call control function initiates secondary call treatments for the call.

20. The communication network of claim 17 wherein the wireless data network comprises an IMS/WiFi network and the wireless voice network comprises a cellular network.
